(19) United States
(12) Patent Application Publication
(10) Pub. No.: US 2012/0053982 A1
(43) Pub. Date: Mar. 1, 2012

(54) Standardized Technology and Operations Risk Management (STORM)

(75) Inventors: Robert Treacey, London (GB); Lisa Christine O'Donnell, Charlotte, NC (US)

(73) Assignee: Bank of America Corporation, Charlotte, NC (US)

(21) Appl. No.: 12/873,921

(22) Filed: Sep. 1, 2010

(51) Int. Cl. G06Q 10/00

(52) U.S. Cl. 705/7.28

(57) ABSTRACT

A computer system analyzing a risk by identifying and assessing the risks, determining the disposition of the risks, monitoring and mitigating the risks, and reporting the risk items across an information technology system. A risk assessment tool may map known risk items into a risk framework as well as map risk categories between different risk frameworks. The risk management tool may also identify a root cause through a defined root cause dictionary based on an identified risk or the associated risk category of the identified risk. This capability may enable a user to analyze end-to-end operations, particularly where the main areas of risk are and where new controls or modified existing controls should be implemented. The risk management tool may also provide risk assessment reports that that are expressed in a common risk language with operations associates, with internal auditors, external auditors and regulatory bodies, and with government agencies.

### FIELD

Aspects of the embodiments relate to a computer system that provides end 2 end (E2E) risk management capabilities (identification, measurement, disposition, monitoring, mitigation and reporting) across a global IT environment.

### BACKGROUND

Risk management is a process that allows any associate within or outside of a technology and operations domain to balance the operational and economic costs of protective measures while protecting the IT environment and data that supports the mission of an organization. Risk is the net negative impact of the exercise of vulnerability, considering both the probability and the impact of occurrence. However, the risk management process may not be unique to the IT environment; pervading decision-making in all areas of our daily lives. For example, a homeowner may decide to have a home security system installed and pay a monthly fee to a service provider to have the security system monitored for protecting the homeowner's property. The homeowner weighs the cost of system installation and monitoring against the value of household goods and homeowner's safety, which is a fundamental “mission” need.

An organization typically has a mission. In this digital era, an organization often uses an automated IT system to process information for better support of the organization's mission. Consequently, risk management plays an important role in protecting an organization's information assets. An effective risk management process is an important component of a successful IT security program. The principal goal of an organization's risk management process should be to protect the organization and its ability to perform the mission, not just its IT assets. Thus, the risk management process should not be treated primarily as a technical function carried out by the IT experts who operate and manage the IT environment but as an essential management function of the organization.

The objective of performing risk management is to enable the organization to accomplish its mission(s) (1) by better securing the IT systems that store, process, or transmit organizational information; (2) by enabling management to make well-informed risk management decisions to justify the expenditures that are part of an IT budget; and (3) by assisting management in authorizing (or accrediting) the IT systems on the basis of the supporting documentation resulting from the performance of risk management.

### BRIEF SUMMARY

Aspects of the embodiments address one or more of the issues mentioned above by disclosing methods, computer readable media, and apparatuses that provide identification, measurement, disposition, monitoring, mitigation, and reporting of known risk items across an IT environment. The risk management tool may also map known risk items into a standard, universally recognized risk framework, which in turn may map to other standard, universally recognized risk frameworks.

According to an aspect of the invention, the management of known risk items is performed in a centralized basis. For example, a list of risks may be defined over the entire organization, rather than a division of the organization. Moreover, the risks may be mapped to different risk frameworks, thus tailoring the reporting of identified risks and the effects on the organization based on the targeted audience of the report (e.g., IT operations associates, internal auditors, external auditors, regulatory bodies, and government agencies).

According to another aspect of the invention, a risk management computer system obtains risk information for an identified risk, where the risk information includes a specified risk framework. The risk category of the identified risk is mapped from the specified risk framework to another risk framework, and a risk report is generated based on the risk framework. For example, Information Technology Infrastructure Library (ITIL) may be the primary risk category (framework). By mapping a risk item to a specific ITIL process within the ITIL risk category (framework), the corresponding Control Objectives for Information and related Technology (COBIT) and the United States National Institute of Standards and Technology (NIST) process or processes within the COBIT and NIST risk categories (frameworks) may be highlighted. There may be a 1 to 1 or 1 to N mapping. If a 1 to N mapping is applicable, then a user has the option to select 1 or multiple processes within the COBIT and NIST risk categories (framework). A user may then drill down into the risk report based on a selected risk attribute.

According to another aspect of the invention, an identified risk may be mapped to a root cause based on the risk category of the identified risk. Mapping a risk into a risk category (framework) and subsequently to a root cause may provide an ability to show, at a low level, the highest areas of risk within an E2E environment and then to analyze if any existing controls are effective or need improvement as well as implementation of additional controls. An existing control may be modified or a new control may be created based on the root cause. Furthermore, an existing control may be correlated to a second control so that the impact on the second control may be determined when modifying the existing control.

According to another aspect of the invention, a risk management computer system may obtain risk information about an identified risk and determine a risk score for the identified risk based on a risk priority number (RPN) and at least one additional risk factor. At least one mitigation milestone may be determined, which once flagged as complete, reduces the risk level of the identified risk. Consequently, the risk score is adjusted to obtain a residual score based on the weighting factor of the completed milestone.

Aspects of the embodiments may be provided in a computer-readable medium having computer-executable instructions to perform one or more of the process steps described herein.

These and other aspects of the embodiments are discussed in greater detail throughout this disclosure, including the accompanying drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative operating environment in which various aspects of the invention may be implemented.

FIG. 2 is an illustrative block diagram of workstations and servers that may be used to implement the processes and functions of certain aspects of the present invention.

FIG. 3 shows a flow chart for analyzing a risk based on a specified risk framework and shows steps of the process when identifying a known risk item in accordance with an aspect of the invention.

FIG. 4 shows a flow chart for determining a risk score for a specified risk in accordance with an aspect of the invention.

FIG. 5 shows a flow chart for determining a residual risk score for a specified risk in accordance with an aspect of the invention.

FIG. 6 shows a flow diagram for determining the disposition of a risk in accordance with an aspect of the invention.

FIG. 7 shows an illustrative screen shot for a summary of a risk in accordance with an aspect of the invention.

FIG. 8 shows an illustrative screen shot for a mitigation of a risk in accordance with an aspect of the invention.

FIG. 9 shows an illustrative screen shot in which risks are viewed by hierarchy in accordance with an aspect of the invention.

FIG. 10 shows an illustrative screen shot for a control inventory summary in accordance with an aspect of the invention.

FIG. 11 shows an illustrative screen shot for control assessment in accordance with an aspect of the invention.

FIG. 12 shows an illustrative bar chart for risk status in accordance with an aspect of the invention.

FIG. 13 shows an illustrative bar chart for risk status in accordance with an aspect of the invention.

FIG. 14 shows an illustrative bar chart for identified process weaknesses with an aspect of the invention. (FIGS. 12, 13 and 14 are all related to risk analysis capabilities of the tool—i.e., the ability to show the highest risk areas at any given point in time or the change in the highest risk areas over a period of time or new and emerging risk areas.)

### DETAILED DESCRIPTION

In accordance with various aspects of the invention, methods, computer-readable media, and apparatuses are disclosed for assessing a risk for an organization. The risk, e.g., a technology or operational risk, may be associated with infrastructure, applications or controls that support one or more operations of the organization, where the infrastructure or applications may comprise an information technology (IT) system.

With embodiments of the invention, a risk management tool provides identification, measurement, disposition, monitoring, mitigation, and reporting of known risk items across an IT environment as well as processes, people, and other systems associated with the IT environment. The risk management tool may also map known risk items into a standard, universally recognized risk framework, including Information Technology Infrastructure Library (ITIL), Control Objectives for Information and related Technology (COBIT), and the risk management framework specified by the United States National Institute of Standards and Technology (NIST).

With traditional systems, the identification and measurement of risks are typically performed on a disjointed basis, e.g., over a division of an organization. For example, a financial organization may support different operations, including, electronic commerce, mortgage loans, car loans, global banking, and credit cards. Consequently, risk analysis by traditional systems is often inconsistent with variances over the entire organization. With an aspect of the invention, risk management is performed on a centralized basis. For example, a list of risks may be defined as impacting the entire organization rather than a division of the organization. Moreover, known risk items may be associated with different risk frameworks, thus tailoring the reporting of identified risks and the effects on the organization based on the audience of the report (e.g., IT operations associates, internal auditors, external auditors, regulatory bodies, and government agencies).

With an aspect of the invention, the risk management tool may identify a root cause, through a defined root cause dictionary, based on a known identified risk or the associated risk category of the identified risk. For example, the identified risk may be mapped to an ITIL process (risk category) “capacity management,” which may in turn be mapped to the root cause “insufficient capacity on server.” This capability enables analysis of the operating environment and the ability to identify the main areas of risk or risk focus as well as helping to determine if current controls are ineffective and need improving or if controls are missing and new controls need to be implemented.

With another aspect of the invention, the risk management tool provides risk reports that facilitate a common risk language between IT operations associates (e.g., ITIL), between internal auditors, external auditors and regulatory bodies (e.g., COBIT), and between government agencies (e.g., NIST risk management framework). The risk management tool may facilitate cross analysis and correlation between known risk items and facilitate the identification of recurring risk themes and trends.

According to an aspect of the invention, risk management capabilities include consistent identification, measurement, mitigation, monitoring, and reporting of known risks. A risk management computer system may be scalable for portability when connecting to risk management tools as the tools become available. The risk management computer system may also act as a system of record for identifying all E2E technology and operations key controls within a “Controls Inventory” and subsequent periodic assessment, to ensure effectiveness of these controls, through a “Controls Assessment Program.” The risk management computer system may identify and track known risks by financial hierarchy and align known risks into standardized risk frameworks. Consequently, consistent risk ratings may be generated for more effective prioritization and for ensuring consistent scoring of risks. Self-identified risks may be aligned to audit issues to facilitate proactive remediation and cross analysis of risks.

According to an aspect of the invention, key stakeholders (e.g., first line of defense (LOD)-lines of business (LOB), second LOD—governance and control, and third LOD—audit) of known risks may be identified.

According to an aspect of the invention, customized reporting for the known risk items may be generated and e-mail notifications sent out to relevant associates when new risk items are either identified or when risk items change status. The reporting may assist with enhancing risk profile management.

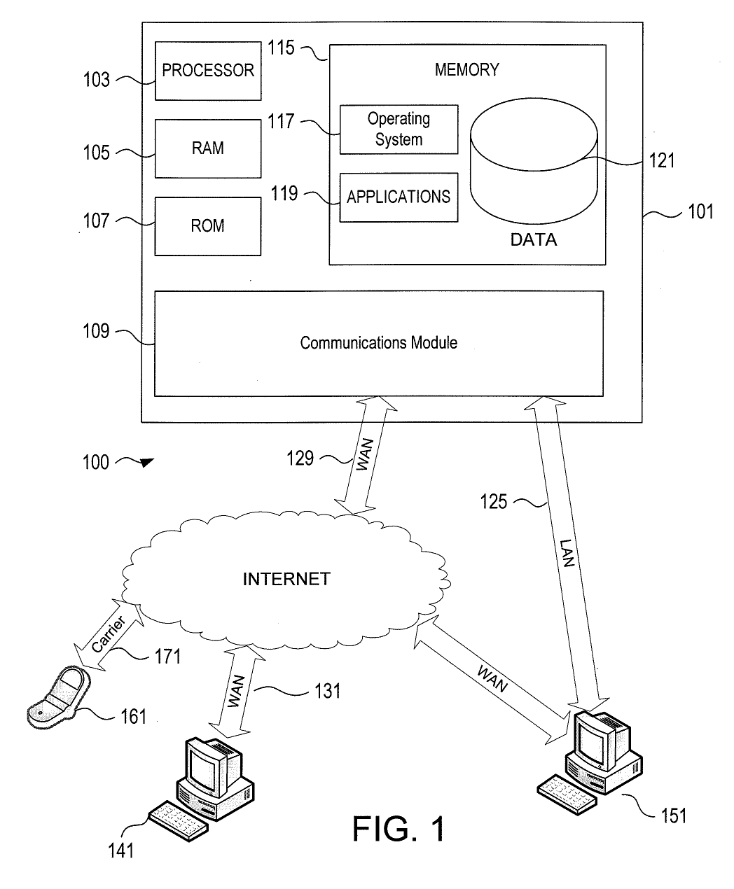

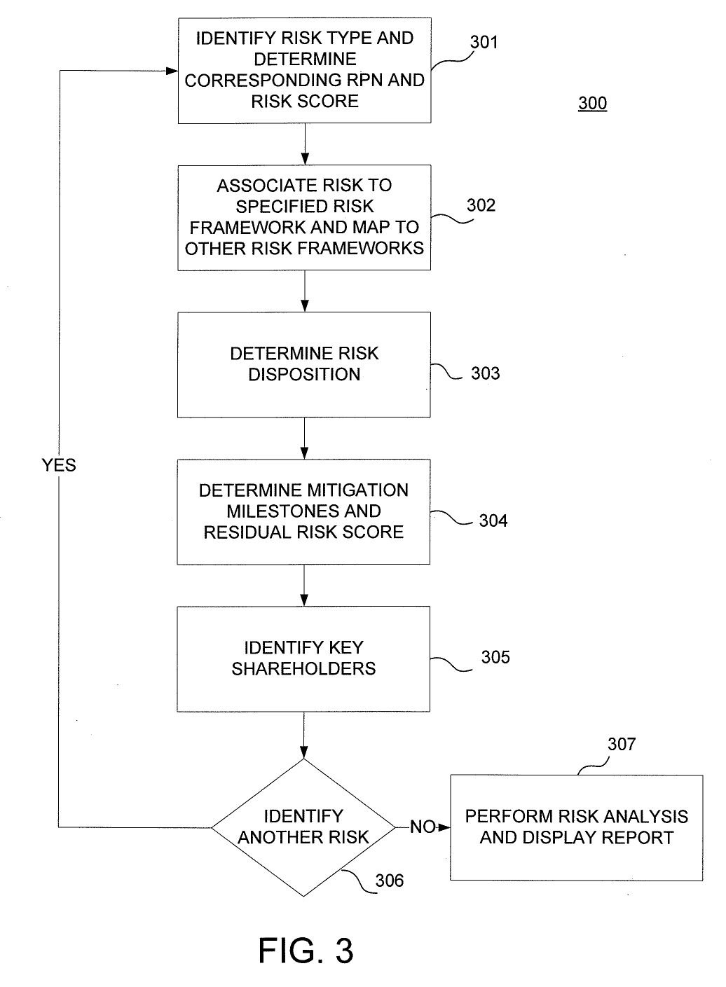

FIG. 1 illustrates an example of a suitable computing system environment 100 (e.g., for processes 300, 400, 500, 600 as shown in FIGS. 3, 4, 5, and 6, respectively) that may be used according to one or more illustrative embodiments. The computing system environment 100 is only one example of a suitable computing environment and is not intended to suggest any limitation as to the scope of use or functionality of the invention. The computing system environment 100 should not be interpreted as having any dependency or requirement relating to any one or combination of components shown in the illustrative computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown). Database 121 may provide centralized storage of risk information including attributes about identified risks, characteristics about different risk frameworks, and controls for reducing risk levels that may be received from different points in system 100, e.g., computers 141 and 151 or from communication devices, e.g., communication device 161.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. Branch computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 is connected to the LAN 825 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the invention is contemplated. For example, aspects of the method steps disclosed herein may be executed on a processor on a computing device 101. Such a processor may execute computer-executable instructions stored on a computer-readable medium.

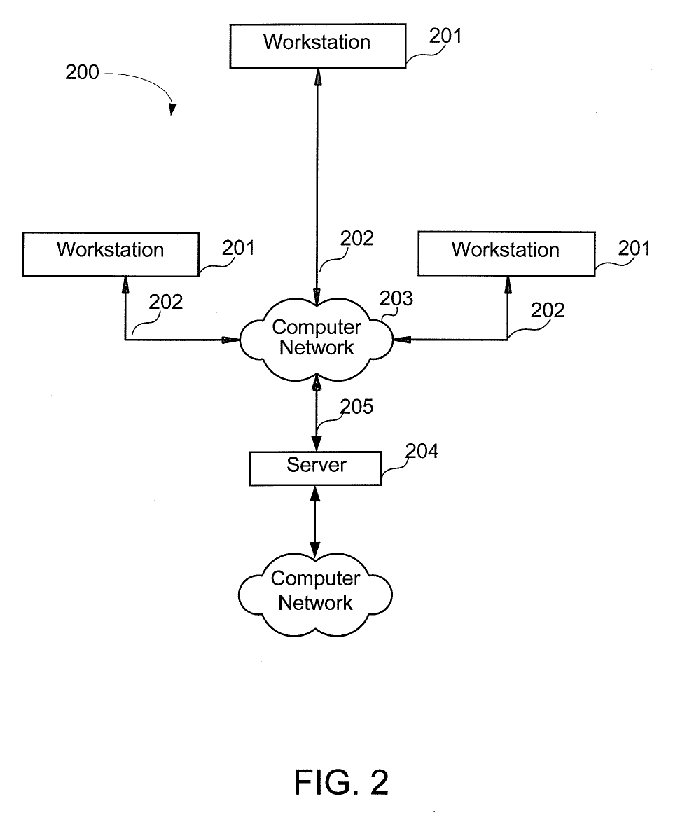

Referring to FIG. 2, an illustrative system 200 for implementing methods according to the present invention is shown. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc. Connectivity may also be supported to a CCTV or image/iris capturing device.

The steps that follow in the Figures may be implemented by one or more of the components in FIGS. 1 and 2 and/or other components, including other computing devices.

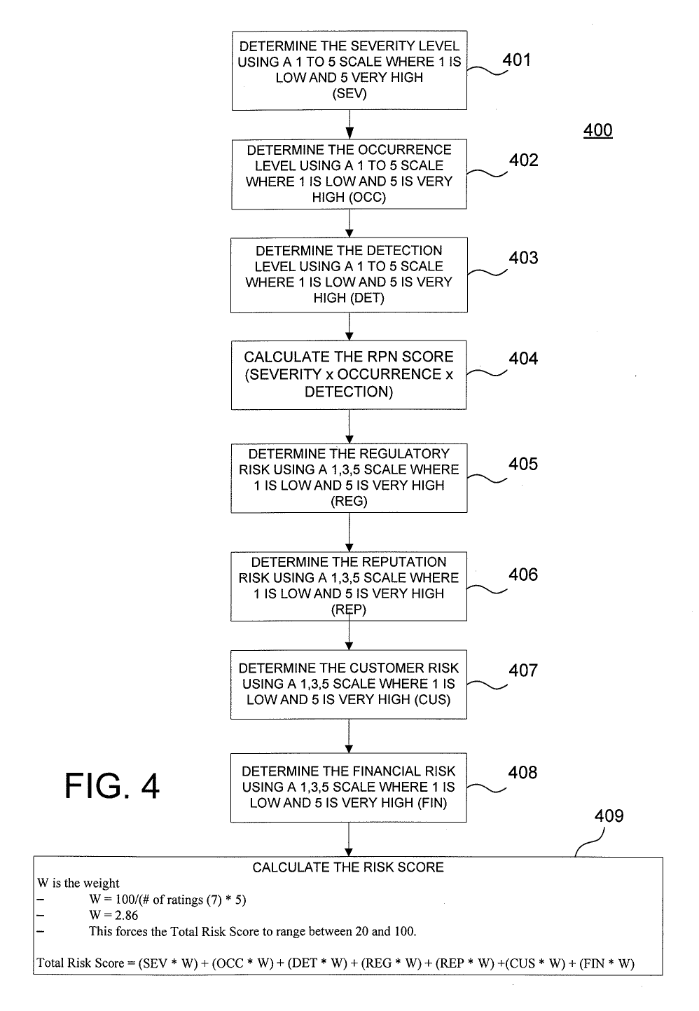

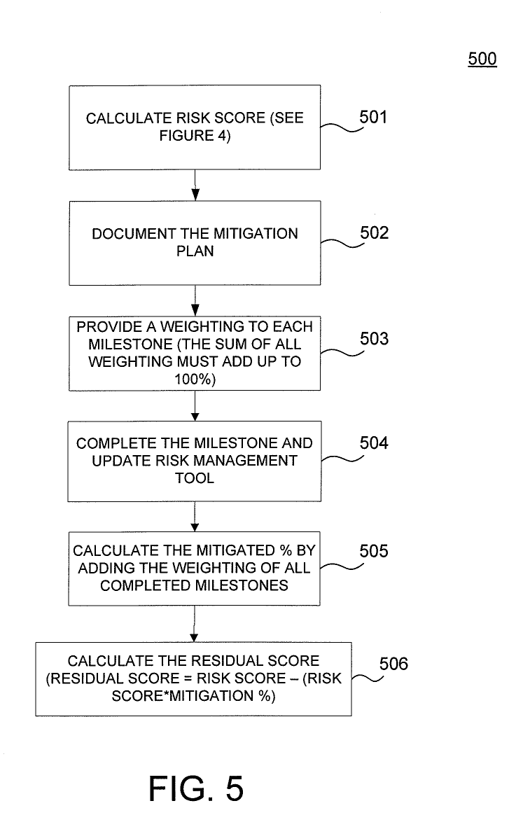

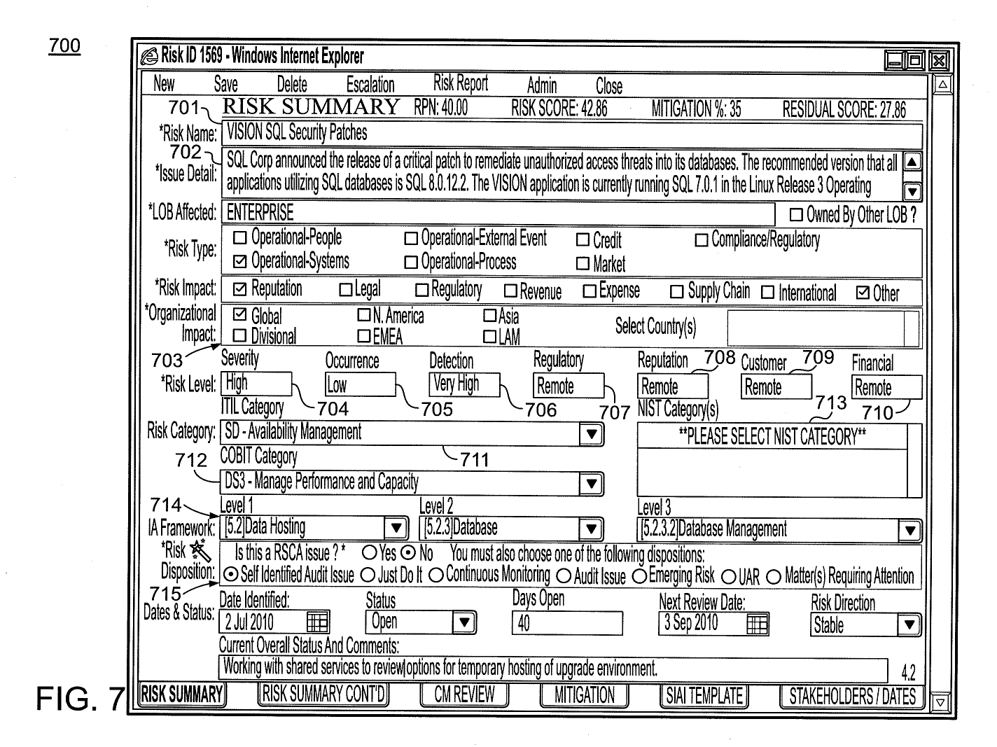

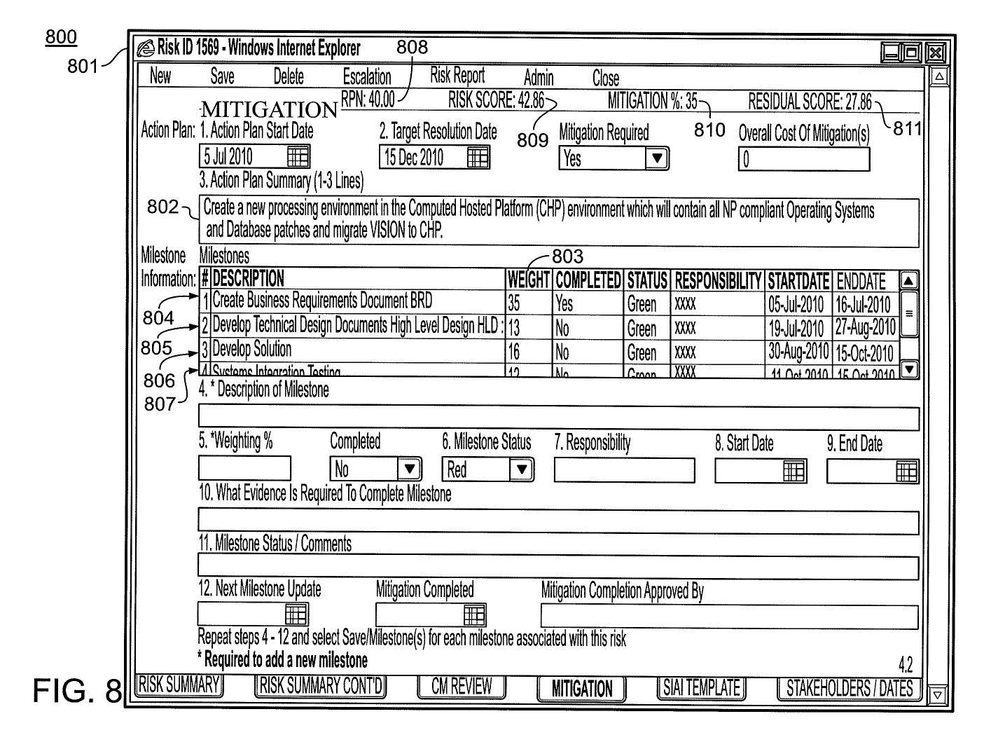

FIG. 3 shows flow chart 300 for measuring a risk in accordance with an aspect of the invention. At block 301 a risk is identified and the corresponding risk level (e.g., risk priority number (RPN) and the risk score), as will be further discussed with FIG. 4, are determined from risk information that may be entered by a user as will be further discussed with FIG. 7. With some illustrative embodiments, possible known risks may number in the hundreds, where each risk is associated with a risk category (commonly known as a risk framework). An illustrative operational risk may be “Default database accounts with default passwords” that may be entered in various ways, including a free formatted text field (risk name 701 as shown in FIG. 7), a pop-up menu (not explicitly shown), or by matching the entered text to a list of defined risks (not explicitly shown).

At block 302, the identified risk is mapped to a specified risk framework by associating the identified risk to a process within a risk category (framework) (e.g., Demand Management in risk category 711 as shown in FIG. 7). Embodiments may support different frameworks including Information Technology Infrastructure Library (ITIL), Control Objectives for Information and related Technology (COBIT), and the risk management framework specified by the United States National Institute of Standards and Technology (NIST).

Information Technology Infrastructure Library (ITIL) is a set of concepts and practices for Information Technology Services Management (ITSM), IT development, and IT operations. ITIL gives detailed descriptions of a number of important IT practices and provides comprehensive checklists, tasks and procedures that any IT organization may tailor to its needs. ITIL is published in a series of books, each of which covers an IT management topic. Information Technology Infrastructure Library (e.g., ITIL v3) encompasses service strategy, service design, service transition, service operation, and continual service improvement.

ITIL service strategy is typically associated with clarification and prioritization of service-provider investments in services. More generally, service strategy focuses on helping IT organizations improve and develop over the long term. Service strategy relies upon a market-driven approach. Key topics covered include service value definition, business-case development, service assets, market analysis, and service provider types. Different processes are associated with service strategy, including service portfolio management, demand management, IT financial management, and supplier management.

ITIL service design is associated with the design of IT services, processes, and other aspects of the service management effort. Service design within ITIL may encompass the elements relevant to technology service delivery, rather than focusing solely on design of the technology itself. Service design may address how a planned service solution interacts with the larger business and technical environments, service management systems required to support the service, processes that interact with the service, technology, and architecture required to support the service, and the supply chain required to support the planned service. Processes associated with service design include service catalog management, service level management, risk management, capacity management, availability management, IT service continuity management, information security management, compliance management, IT architecture management, and supplier management.

ITIL service transition relates to the delivery of services required by a business into live/operational use and often encompasses the project side of IT. Associated processes include service asset and configuration management, service validation and testing, evaluation, release management, change management, and knowledge management.

ITIL service operation relates to achieving the delivery of agreed levels of services both to end-users and the customers (where “customers” refer to those individuals who pay for the service and negotiate the SLAs). Service operation may be the part of the lifecycle where the services and value is actually directly delivered. Also, the monitoring of problems and balance between service reliability and cost may be considered. Service operation may include technical management, application management, operations management and service desk as well as responsibilities for staff engaging in service operation. Associated processes include event management, incident management, problem management, request fulfillment, and access management.

ITIL continual service improvement (CSI) aligns IT services to changing business needs by identifying and implementing improvements to the IT services that support business processes. The perspective of CSI on improvement is the business perspective of service quality, even though CSI aims to improve process effectiveness, efficiency, and cost effectiveness of the IT processes through the whole lifecycle. To manage improvement, CSI should clearly define what should be controlled and measured. Associated processes include service level management, service measurement and reporting, and continual service improvement.

A process within a standard risk framework may be referred to as a risk category. For example, a user may identify a risk “VISION SQL Security Patches” in field 701 as shown in FIG. 7. The risk may be associated with ITIL risk category “Availability Management” 711 (associated with ITIL service design as described above), which in turn maps to COBIT risk category “Manage Performance and Capacity” 712.

Control Objectives for Information and related Technology (COBIT) is another risk framework, in which a set of best practices (framework) for information technology (IT) management was created by the Information Systems Audit and Control Association (ISACA) and the IT Governance Institute (ITGI) in 1996. COBIT provides managers, auditors, and IT users with a set of generally accepted measures, indicators, processes and best practices to assist them in maximizing the benefits derived through the use of information technology and developing appropriate IT governance and control in a company. Its mission is to research, develop, publicize and promote an authoritative, up-to-date, international set of generally accepted information technology control objectives for day-to-day use by business managers and auditors. Managers, auditors, and users benefit from the development of COBIT because it helps them understand their IT systems and decide the level of security and control that is necessary to protect their companies' assets through the development of an IT governance model. For example, COBIT version 4.1 has 34 high level processes that cover 210 control objectives categorized in four domains: planning and organization, acquisition and implementation, delivery and support, and monitoring and evaluation.

The NIST risk assessment framework provides guidance for securing the IT systems that store, process, or transmit organizational and for enabling management to make well-informed risk management decisions to justify the expenditures that are part of an IT budget; and (3) by assisting management in authorizing (or accrediting) the IT system on the basis of the supporting documentation resulting from the performance of risk management. For example, the NIST risk assessment framework is discussed in NIST Special Publication 800-30 “Risk Management Guide for Information Technology Systems.”

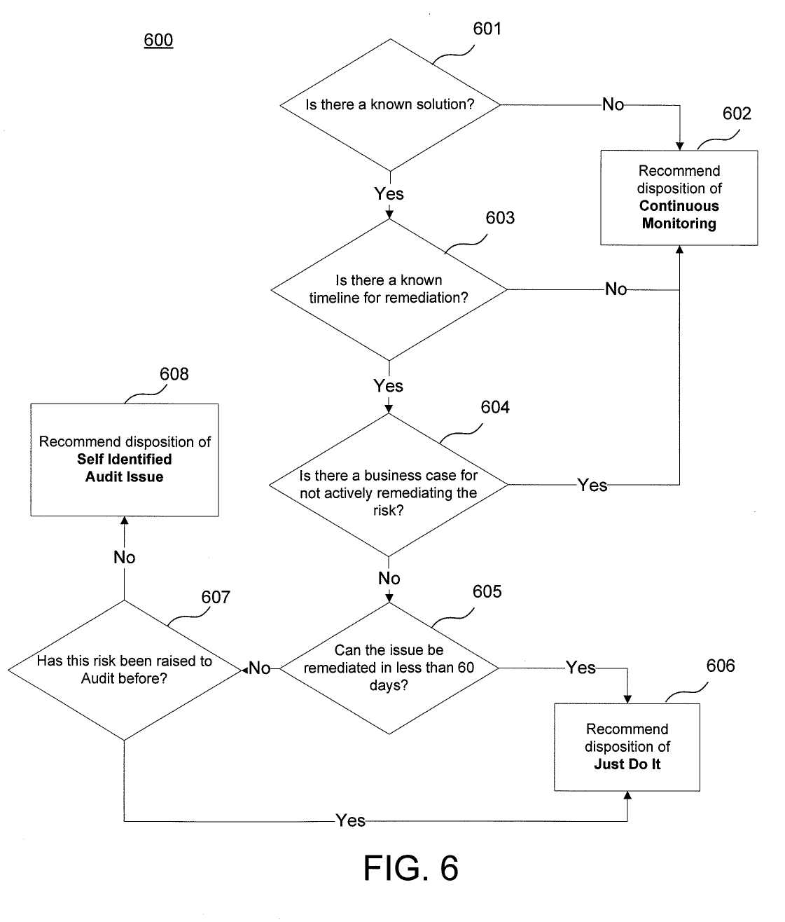

Referring to FIG. 3, at block 303, the risk disposition of the identified risk is determined. The risk disposition may be determined based on the severity of the risk, timeframe for remediating the risk and whether the risk has a known solution, as will be further discussed with FIG. 6. With some embodiments, a user is guided by a software wizard that reflects disposition criteria. When the user has answered the questions presented by the wizard, a risk disposition may be displayed to the user so that the user can enter it into field 715 as shown in FIG. 7. However with some embodiments, the wizard may automatically populate the disposition field without the user directly entering information.

At block 304 mitigation milestones may be determined that will reduce the degree of risk for the identified risk when the milestones have been completed. For example, as shown in FIG. 8, mitigation milestones 804, 805, 806, 807 are entered with weights 35%, 13%, 16%, and 12%, respectively, for risk ID 801. (There may be more milestones that are not explicitly shown in FIG. 8, and consequently the sum of the weights for milestones 804, 805, 806, and 807 does not equal 100%.) When a mitigation milestone has been competed, risk score 809 is reduced based on the associated weight to obtain residual score 811.

At block 305, key stakeholders of known risks are identified. For example, key stakeholders may include lines of business (LOB) corresponding to a first line of defense (LOD), governance and control corresponding to a second LOD, and audit corresponding to a third LOD.

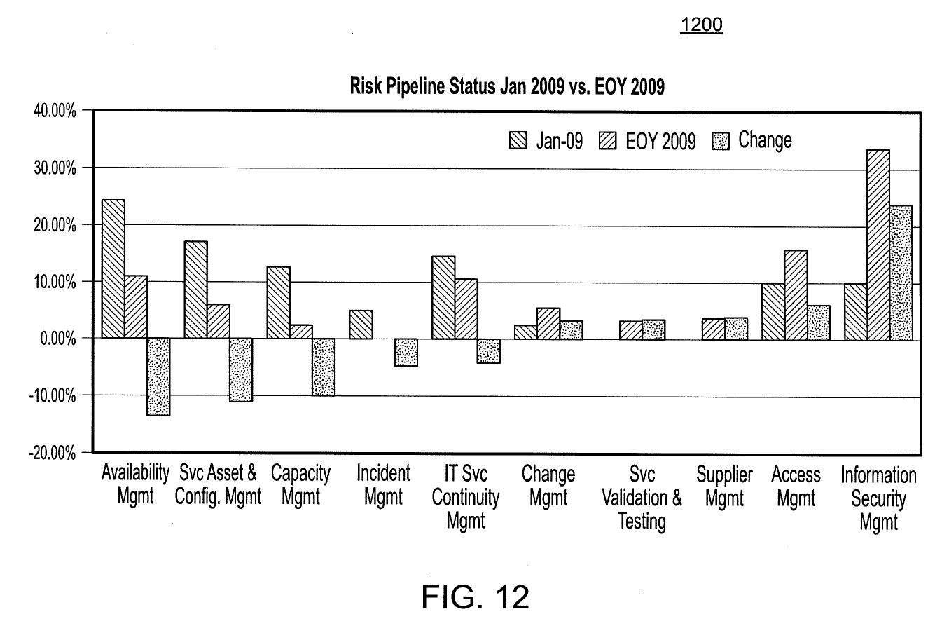

Block 306 determines whether additional risk items should be created or edited. If not, a risk report may be presented at block 307 that summarizes the identified risks based on one or more attributes. For example, a risk indicator is displayed for different ITIL processes (risk categories) in FIGS. 12-14. For illustrative screen shots 1200-1400, information security management 1202 has the largest number of risks with respect to the other risk categories both at the beginning of year 2009 as well as at the end of year 2009. While ITIL categories are displayed, another report may be generated with risk categories for other risk frameworks, e.g., COBIT or NIST, if the targeted audience of the report is different.

Risk Reporting and risk analysis reporting are typically two separate activities. For example, a risk management tool may provide risk reporting that may be filtered by disposition, RPN value, date values, hierarchy, accountability, and the like. Risk analysis reporting may be performed from the mapping of known risks into frameworks (risk categories/processes) and may assist to identify trends within the environment as well as the ability to identify, at any given point, where the highest areas of risk are.

FIG. 4 shows flow chart 400 for determining a risk score for a specified risk in accordance with an aspect of the invention. At blocks 401-403, the RPN value of the identified risk is determined by multiplying the severity level, occurrence level, and detection level together. Because each level may vary from 1 to 5, the RPN varies from 1 to 125, where the larger the RPN, the greater the risk level.

At blocks 405-408, additional risk factors are obtained, including an associated regulation risk measure, reputation risk measure, customer risk measure, and financial risk measure. The risk score is then determined at block 409 by multiplying each of the above seven risk factors by a weighting factor and then summing the seven resulting components. Consequently, the risk level varies from 20 to 100, where the larger the value, the greater the inherent degree of risk.

FIG. 5 shows flow chart 500 for determining a residual score for an identified risk in accordance with an aspect of the invention. At block 501, the risk score of the identified risk is determined at block 409 as shown in FIG. 4. A mitigation plan (e.g., mitigation milestones 804-807 as shown in FIG. 8) is entered and documented at block 502. Each milestone is weighted by a relative degree of importance at block 503, where the sum of all of the weighting factors equals 100%. With some embodiments, the mitigation milestones may not be completed in sequential order as entered mitigation milestones 804-807.

When a mitigation milestone is completed, an indication is entered through the risk management tool at block 504 so that the completed mitigation percentage is determined at block 505. At block 506, the residual score of the identified risk is determined by:

residual_score=risk score*(1−completed_mitigation_percentage) (EQ. 1)

FIG. 6 shows flow chart 600 for determining the risk disposition of a risk in accordance with an aspect of the invention. An identified risk is classified in one of a plurality of disposition categories. With the illustrative embodiment shown in FIG. 6, disposition categories include “Just Do It” (JDI), “Self Identified Audit Issue” (SIAI), “Urgent Audit Requirement” (UAR), and “Continuous Monitoring” (CM) based on disposition criteria.

At block 601, it is determined whether the identified risk has a known solution. If not, an indicator is generated at block 602 that is indicative of continuous monitoring. The indicator may be text output to a user and/or automatic generation of the risk disposition in an appropriate field of a screen shot (e.g., risk disposition field 715 as shown in FIG. 7).

At block 603, flow chart 600 further determines whether there is a known timeline of remediation for the identified risk. If not, the recommended disposition is continuous monitoring at block 602. If so, process 600 determines whether there is a business case for not actively remediating the risk at block 604. If so, the recommended disposition is continuous monitoring at block 602. If not, process 600 determines whether the identified risk can be remediated in less than 60 days at block 605. If so, process 600 recommends the disposition “Just Do It” at block 606. If not, process 600 determines whether the identified risk has been raised to Audit before at block 607. If so, the recommended disposition is “Just Do It” (corresponding to block 606). If not, the recommended disposition is “Self Identified Audit Issue” (corresponding to block 608).

As previously discussed, a user may be guided by a software wizard that reflects disposition criteria. When the user has answered the questions presented by the wizard, a risk disposition may be displayed to the user so that the user can enter it into field 715 as shown in FIG. 7. However with some embodiments, the wizard may automatically populate the disposition field without the user directly entering information. With some embodiments, the wizard may associate an identified risk with one of the disposition categories when the following criteria are met:
JDI disposition category:
1) Has a known solution.
2) When initially identified, is generally a low risk, with an RPN of ≦27, which may be considered equivalent to a severity 3 audit issue.
(For example, a high level risk is defined as having an RPN ≧64 and may equate to a Severity 1 Corporate Audit issue. A medium level risk is defined as having an RPN between 28 and 63 and may equate to a Severity 2 Corporate Audit issue. A low level risk is defined as having an RPN≦27 and may equate to a Severity 3 Corporate Audit issue. The RPN may be calculated by multiplying “Severity” by “Occurrence/Frequency” by “Detection,” where each element is rated on a 1 to 5 scale.)
3) Is rejected as an SIAI by Corporate Audit, but is still in need of remediation. Such risks can be any risk level or severity level.
4) May qualify as an SIAI, but can be remediated in <60 days.
5) Is not being addressed in an active project.
6) Is not categorized as a UAR.

The JDI disposition category may be directed to efforts to enhance existing effective controls (e.g., raising the bar).
SIAI disposition category:
1) Has a known solution.
2) Is typically considered to be a medium to high level risk
3) Requires longer than 60 days to remediate.
4) Is not being addressed in an active project.
5) Has not been raised to audit before as an audit or self-identified issue.
6) Meets one of the audit severity definitions.
7) Results from the absence of control or ineffective control.
8) When raised with an audit severity of 2 requires band 2 executive approval.
9) When raised with an audit severity of 1, requires band 2 and band 1 executive approval.
A business may have an associate hierarchy that is structured into bands 1 to 10 (where 1 is most senior and 10 is most junior). Risks with an RPN ≧64 (corresponding to a possible severity 1 audit issue) may require both band 1 and band 2 approval and risks with an RPN between 28 and 63 may require band 2 approval.
10) Identify and address the root cause of the risk.
11) Ensure the sustainability of the remediation.

The SIAI disposition category may be directed to efforts to answering the question: “Where are we lacking controls or what controls are not working effectively?”
UAR disposition category:
1) Has a known solution.
2) Is a high risk.
3) Meets the definition of an audit severity 1.
4) Likely has a risk priority number (RPN)>=64.
5) Must be remediated in <30 days.
6) May be self-raised or raised by Corporate Audit.
7) May be a precursor to an audit finding.
8) May be a finding for remediation without leading to an audit issue.
9) If self-identified, cannot have been raised to audit before (by audit or self-identified).
10) Is not being addressed in an active project.
11) Results from the absence of control or ineffective control.
12) If self-identified, requires band 2 and band 1 executive approval.
CM disposition category:
1) Has no known solution and/or no known timeline for resolution.
2) May be any risk level, audit severity level or any risk priority number (RPN).
3) May include a risk that is being addressed in an active project.
4) May include a risk with documented analysis showing the cost to remediate outweighs the risk.

Continuous monitoring typically differs from risk acceptance and is not typically a means to bypass remediation of the risk item if remediation is considered too costly, resource intensive or inconvenient. Furthermore, continuous monitoring may entail periodic review of the risk, based on the level of risk, and may require the risk owner to report on progress towards mitigation or future elimination of the risk.

FIG. 7 shows illustrative screen shot 700 for a summary of a risk in accordance with an aspect of the invention. Screen shot 700 enables a user to create a new risk or edit an existing risk.

With the illustrative embodiment shown in FIG. 7, a user enters a risk name 701 of the identified risk with a description of the risk in field 702. Fields 701 and 702 may be entered as free-format text. However, some embodiments may provide a pop-up window that displays a list of possible risks so that the user may select one of the pre-defined risks.

The user may specify the organizational impact in area 703 by entering the affected regions and may further select one or more affected countries.

The user further provides risk information about the risk level in fields 704-710. With some embodiments, the risk priority number (RPN) is determined from severity measure 704, occurrence measure 705, and detection measure (ability to detect the risk) 706 by multiplying measures 704, 705, and 706, where each measure has an integer measure from 1 to 5. Consequently, the RPN of the identified risk has a value from 1 to 125, where the larger the RPN, the larger the risk level. As previously discussed, flow chart 400 (as shown in FIG. 4) further determines a risk score for the identified risk by combining the RPN with regulation measure 707, reputation measure 708, customer measure 709, and financial measure 710.

A user may select the ITIL risk category in field 711 by selecting one risk category that is associated with the identified risk. The ITIL risk category acts as the driver and may be mapped to the corresponding COBIT risk category or categories and NIST risk category or categories so that the corresponding risk category or categories are shown in fields 712 and 713. If more than one COBIT or NIST risk category is mapped to the ITIL risk category, than the user may select the appropriate risk category or categories shown in pop-up windows with fields 712 and 713.

In addition to associating the identified risk with a risk category for one or multiple risk frameworks, the identified risk may be mapped to a component of the organization's infrastructure architecture. While the risk category is typically specified in a standardized document, the organization's framework is often specific to the organization. The user may select one of the infrastructure components provided in a pop-up window with field 714. For example, an infrastructure component may correspond to data hosting, business intelligence tools, and management tools at different levels of the infrastructure architecture framework.

The risk disposition is included in field 715 as previously discussed with FIG. 6.

FIG. 8 shows illustrative screen shot 800 for a mitigation of a risk in accordance with an aspect of the invention. Screen shot 800 is typically displayed after the user has viewed screen shot 700 in order to enter a new risk or to edit an existing risk (corresponding to risk id 801). The action plan summary for mitigating the risk is entered as free-format text in field 802. As previously discussed, the risk level of the identified risk may be reduced by completing mitigation milestones (e.g., milestones 804-807). The risk level may be based on risk score 809, which in turn is determined from RPN 808 and measures 707-710 (as shown in FIG. 7). When a mitigation milestone has been completed, risk score 809 is reduced relative to weighting factor 803 associated with the mitigation milestone to obtain residual score 811. Typically, the larger weighting factor 803, the larger the effect of the mitigation milestone on the identified risk. Mitigation % 810 is the sum of weighting factors 803 for milestones that have been completed.

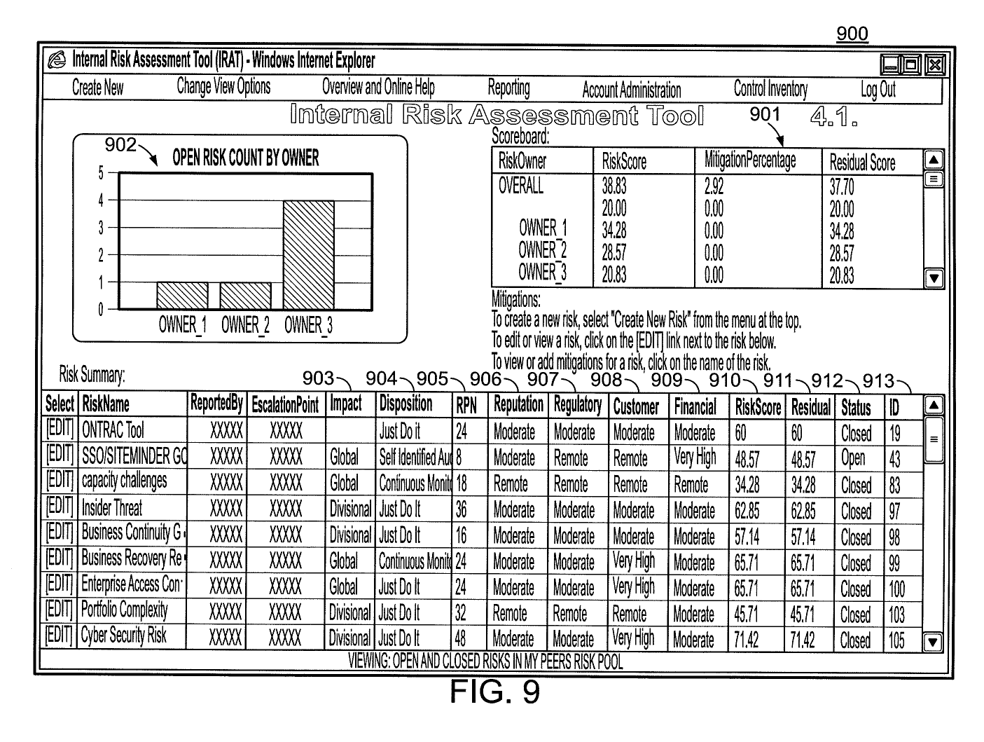

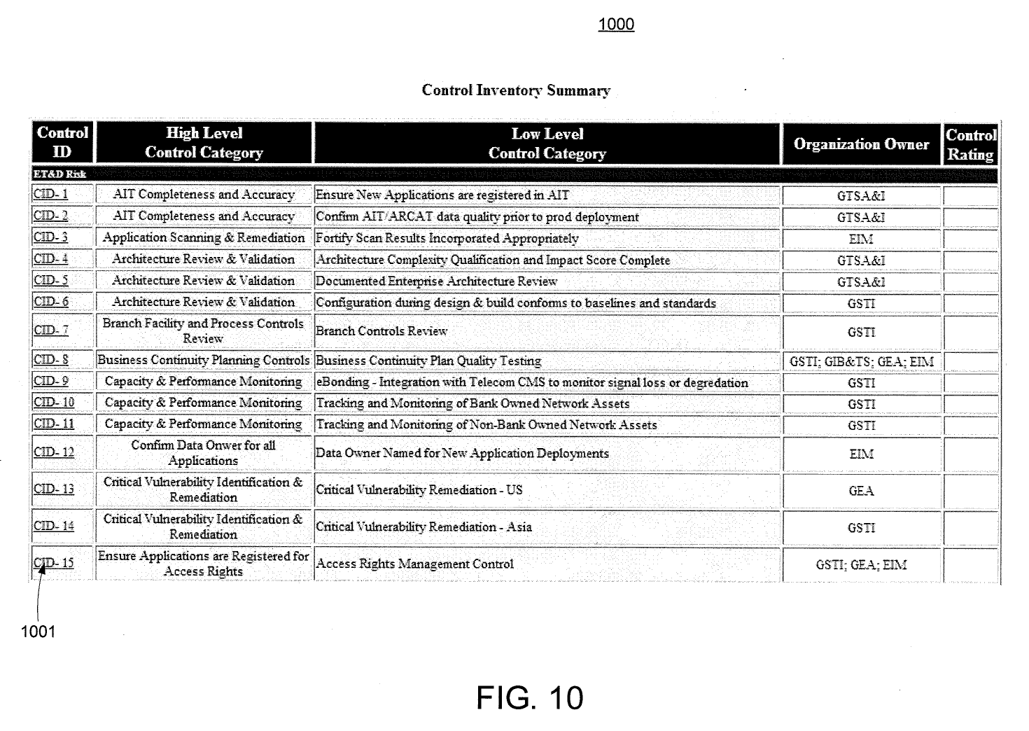

FIG. 9 shows illustrative screen shot 900 in which risks are viewed according to an organization's hierarchy in accordance with an aspect of the invention. For example, a manager may wish to view identified risks for a plurality of subordinates (owners) in the manager's organization. However, a member in the organization may be able only to view risks owned by the owner. Consequently, risk reports may be restricted to the user based on the hierarchy of the organization or by access level provisioning within the risk management tool.

Identified risks may be summarized by owner in scoreboard 901 and in bar graph 902. The user may click on one of the bars in bar graph 902 to obtain a risk summary for risks owned by the associated owner. The user may also sort the risk summary based on values associated with fields 903-913. For example, identified risks associated with a continuous monitoring disposition may be sorted to appear at top of the risk summary or identified risks may be sorted by RPN value, with the highest values at the top of the risk summary.

FIG. 10 shows illustrative screen shot 1000 for a control inventory summary in accordance with an aspect of the invention. Screen shot 1000 shows the key E2E controls (shown as a “Controls Inventory” or “System of Record”) that have been identified and are utilized in the organization's infrastructure to reduce the risk level. For example, entry 1001 corresponds to control id CID-15 that ensures applications are registered for access rights. The controls shown in screen shot 1000 are typically specific for an organization but may be mapped to standard, risk frameworks (ITIL, COBIT and NIST). A control may also be mapped to one or more known risks (either Self Identified or Audit raised) or to a country specific regulatory and/or legal requirement.

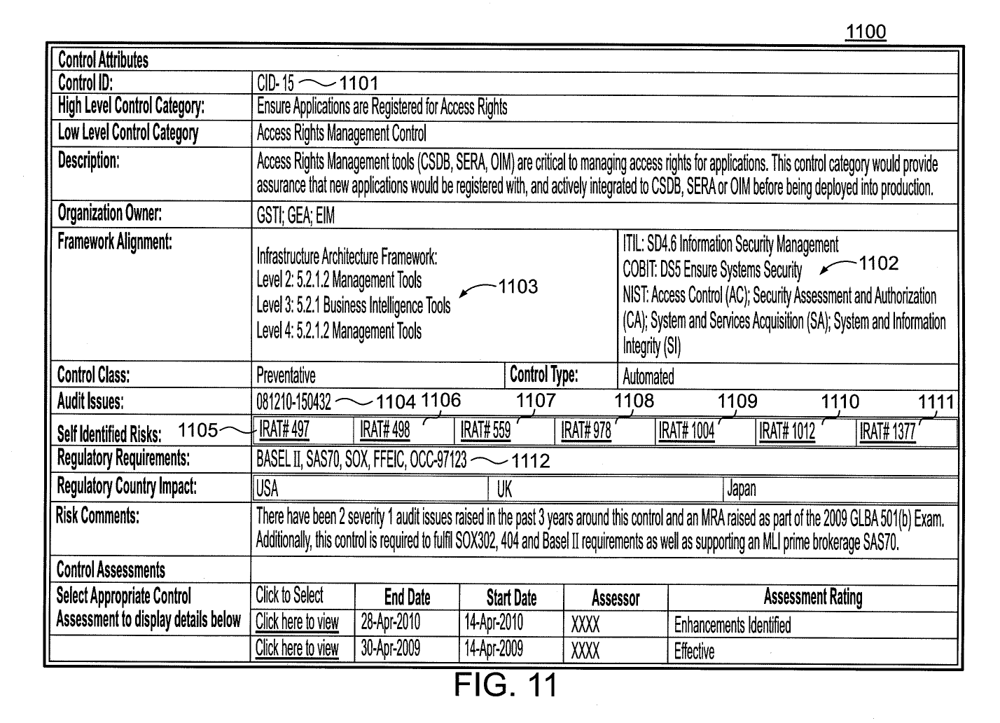

FIG. 11 shows illustrative screen shot 1100 for control assessment in accordance with an aspect of the invention. Screen shot 1100 provides specifics for control id 1101 (CID-15 corresponding to entry 1001 shown as in FIG. 10). Control CID-15 is associated with risk categories shown in area 1102 and with the infrastructure architecture framework shown in area 1103. The control may be mapped to known audit issues (e.g., audit issue 1104), to known self identified risks (e.g., risks 1105-1111), and to known regulatory and legal requirements 1112.

With some embodiments, a control assessment program may be supported in order to test the effectiveness of the controls on a periodic basis.

FIG. 12 shows illustrative bar chart 1200 for risk status based on different risk categories (e.g., ITIL processes) in accordance with an aspect of the invention. With the example shown in FIG. 12, for all known risk items identified as of January 2009, 56.1% were mapped to the ITIL processes of ‘availability management’, ‘service asset and configuration management’, and ‘IT service continuity management’. During the course of 2009, the organization launched the SIAI program to increase the number of risk items in the pipeline. This effort led to a 471% increase in the total number of risk items.

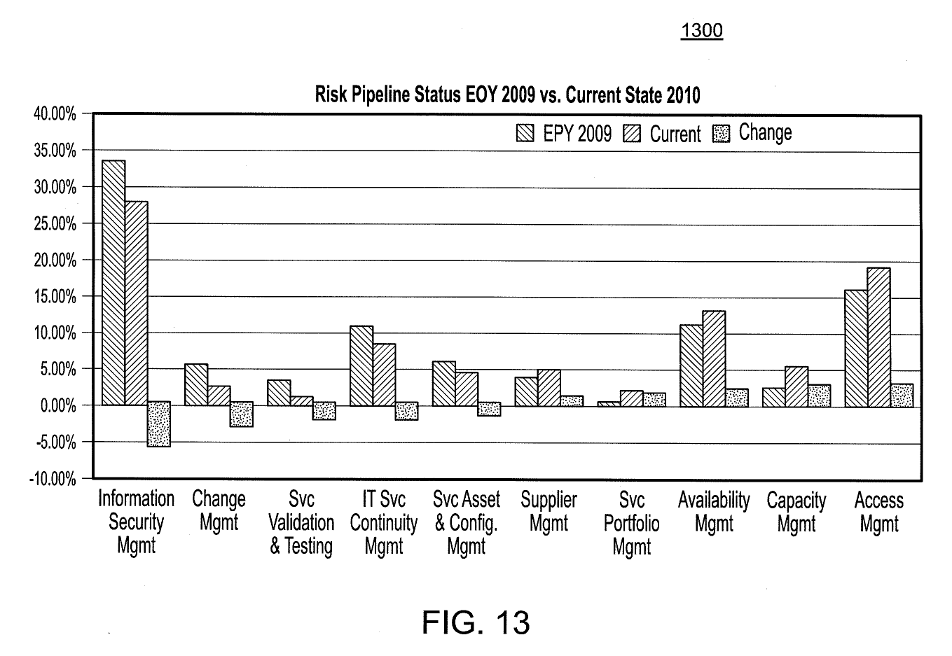

FIG. 13 shows illustrative bar chart 1300 for risk status comparing year 2010 with year 2009 in accordance with an aspect of the invention. Information security management, access management, and availability management accounted for 59% of all risks. In 2010, the organization drove down the number of information security management risks by 5.42%, change management risks by 3.08%, and service validation and testing risks by 2.36%.

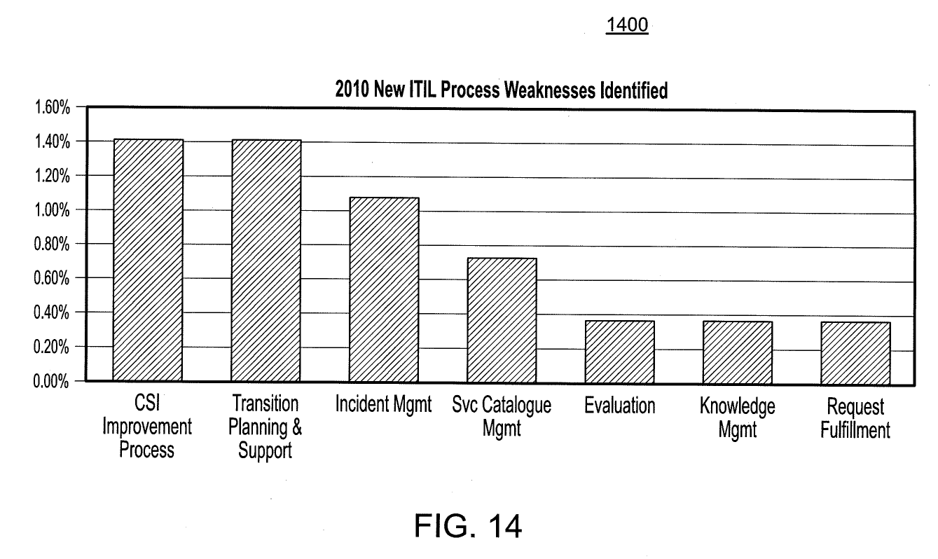

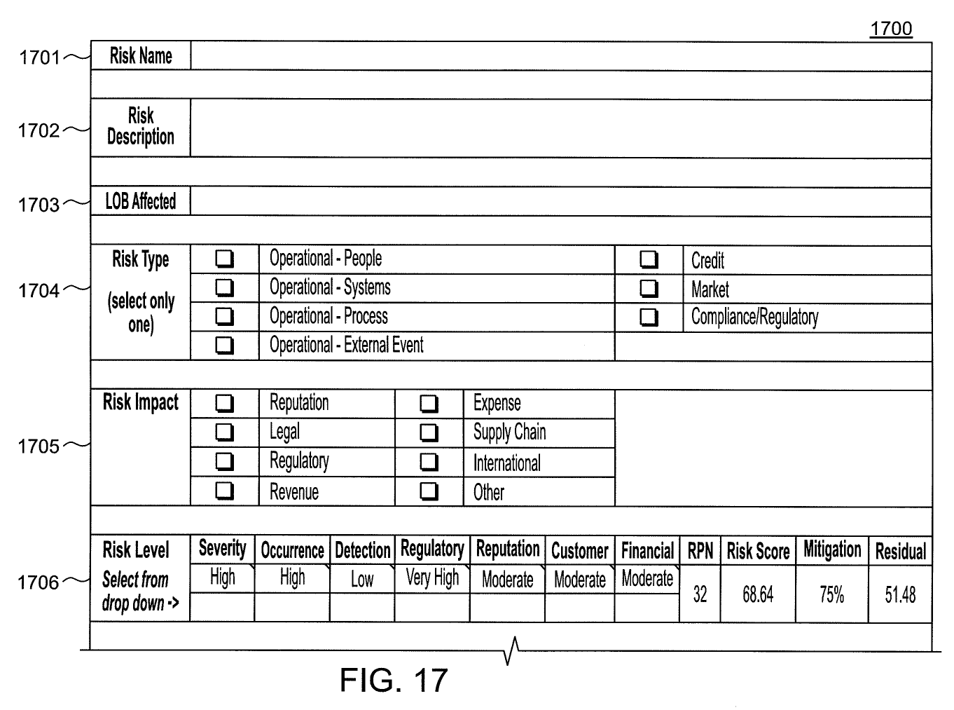

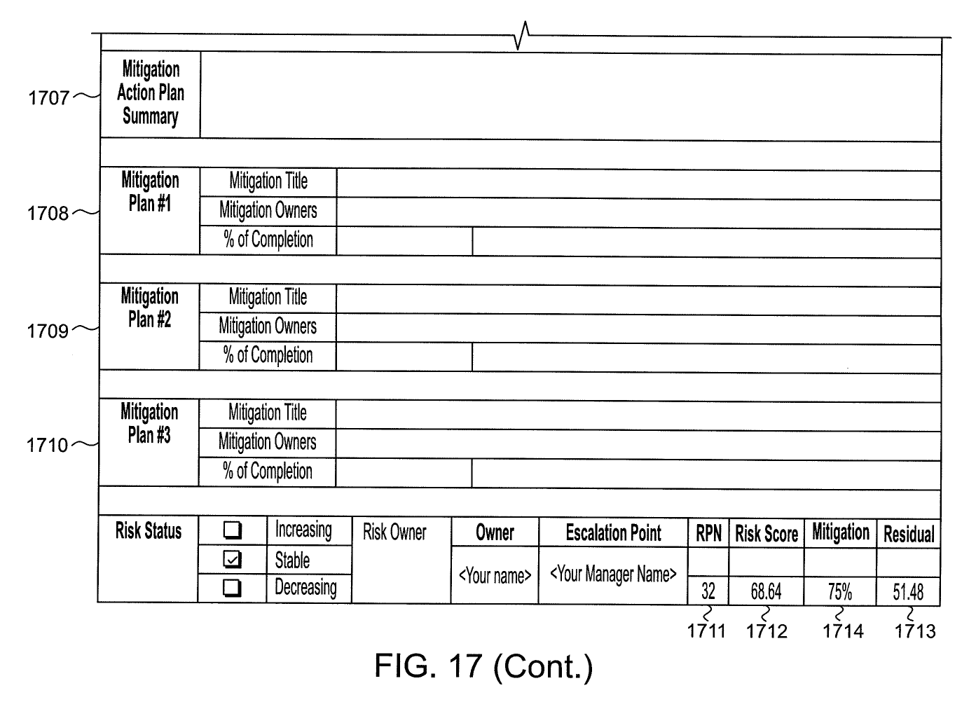

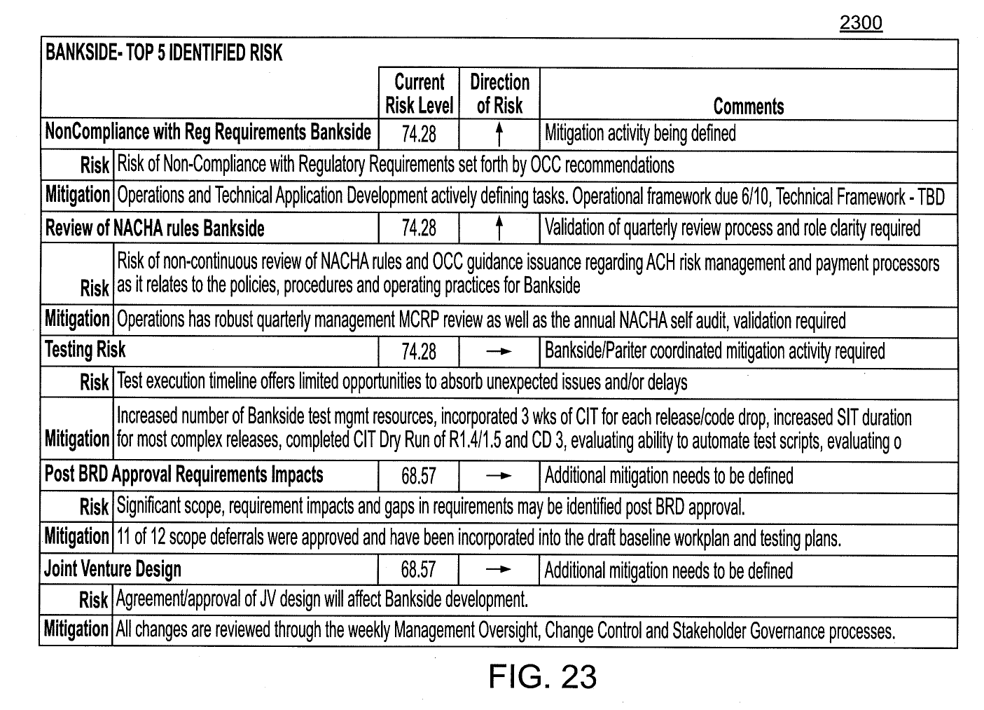

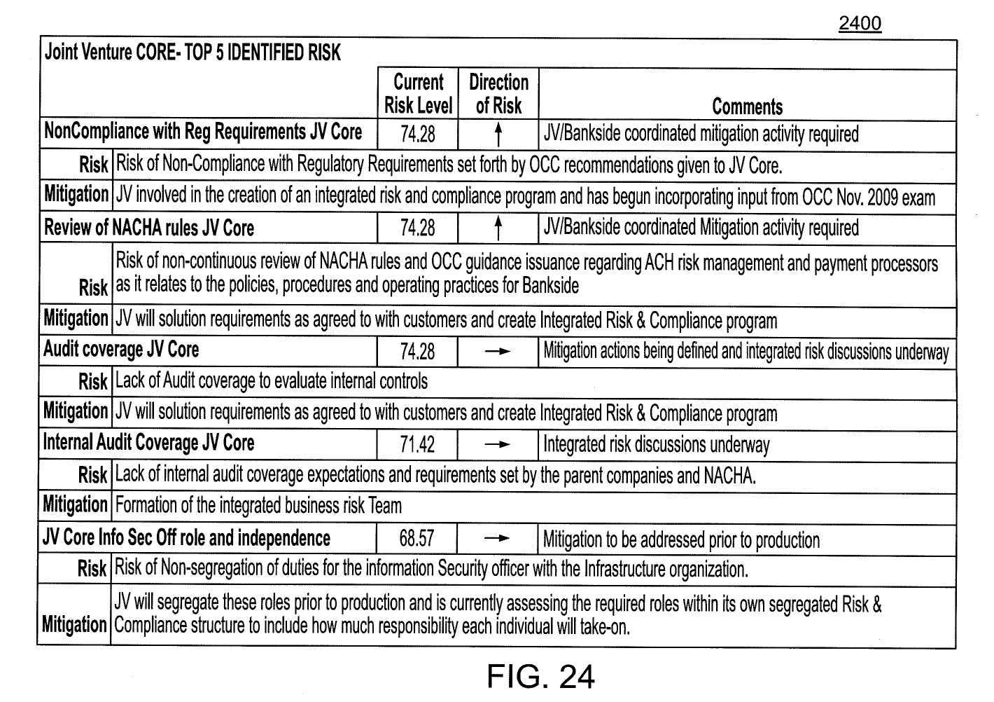

FIG. 14 shows illustrative bar chart 1400 for newly identified process weaknesses with an aspect of the invention. In year 2009 the organization identified the most risks in the following risk categories: information security management, access management, change management, supplier management, and service validation and testing. In year 2010 the organization raised 50 new risks with the following ITIL classification: capacity management, supplier management, access management, and availability management. With this example, access management, availability management, and capacity management continued to see increases in risks identified. Therefore, the organization may need to examine the ineffectiveness of existing controls. In year 2010, new ITIL process weaknesses were identified as follows: CS I improvement process, transition planning and support, incident management, service catalog management, evaluation, knowledge management, and request fulfillment.

While FIGS. 12, 13 and 14 show separate bar graphs 1200, 1300, and 1400, respectively, some embodiments may combine the bar graphs into an integrated screen shot to facilitate risk analysis reporting.

The above illustrative risk analysis helps to ensure that access controls are in place and enables the organization to provide a risk point of view (POV) as to which risks require immediate remediation focus. For example, password and ids criteria should be communicated to all associates to ensure passwords and ids are created with the prescribed criteria. Also, user access rights should be regularly self-audited in order to maintain rights with current associate responsibility. Vendor management should include implemented procedures for the administration of user security on the remote access products.

Also, access rights should be appropriately deactivated. System access for terminated/transferred employees should be removed on a timely manner in accordance with standards and baselines. The listing of terminated/transferred employees should be reviewed on a regular basis to ensure that the terminated/transferred employees have been removed from the system. Regarding availability management, the availability of the organization's resources, services, and components should continue to improve. Availability targets in all areas should be are measured and achieved to match or exceed the current and future agreed needs of the business in a cost effective manner. Regarding capacity management, the organization should focus on capacity and performance related issues, relating to both services and resources to match the capacity of IT to the agreed business demands. The organization should ensure that capacity is considered in the design state to successfully manage capacity.

Referring to FIGS. 7 and 8, various aspects of the invention are illustrated for identified risk SQL security patches (risk ID 1569) as entered in risk name 701. The identified risk is associated with issue 702 (release of critical patch to remediate unauthorized access threats into SQL databases). The risk is associated with ITIL Category 711 (Availability Management), which maps to COBIT Category 712 (Manage Performance and Capacity).

Risk levels are entered into fields 704-710, from which computer system 100 determines the RPN (shown with a value of 40 in field 808 as shown in FIG. 8), risk score (shown with a value of 42.86 in field 809), mitigation percentage (shown with a value of 30% in field 810), and residual score (shown with a value of 27.86 in field 811). The mitigation percentage reflects that mitigation milestone 804 (Create business requirement document) has been completed. However, milestones 805-807 and other milestones that are not explicitly shown in FIG. 8 are still pending.

Also, the risk disposition 715 is recommended to be Self Identified Audit Issue as determined by process 600.

The risk may be associated with one or more controls that may be shown in a control attribute screen shot (similar to screen shot 1100), where one of the self identified risks includes risk ID 1569.

Aspects of the embodiments have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the embodiments. They may determine that the requirements should be applied to third party service providers (e.g., those that maintain records on behalf of the company).

We claim:

1. A computer-assisted method comprising:
obtaining, by a risk management computer system, risk information for an identified risk, the risk information including a first risk framework;
mapping, by the risk management computer system, a risk category of the identified risk from the first risk framework to a second risk framework; and
reporting, by the risk management computer system, a risk analysis report based on one risk framework selected from the first risk framework and the second risk framework according to a targeted audience of the risk analysis report, the risk analysis report including the identified risk.

2. The method of claim 1, further comprising:
revising the risk analysis report according to a different risk framework; and
displaying the revised risk assessment report.

3. The method of claim 1, further comprising:
determining a risk score encompassing a risk priority number and at least one additional risk factor.

4. The method of claim 3, further comprising:
determining at least one mitigation milestone; and
adjusting the risk score to obtain a residual score based on the at least one mitigation milestone.

5. The method of claim 4, wherein the adjusting comprises:
when one of the at least one mitigation factor is completed, reducing the residual score according to a weighing factor associated with said one of the at least one mitigation milestone.

6. The method of claim 1, further comprising:
determining a risk disposition for the identified risk from the risk information.

7. The method of claim 1, further comprising:
mapping the identified risk to a root cause based on the risk category of the identified risk.

8. The method of claim 7, further comprising:
modifying an existing control based on the root cause.

9. The method of claim 7, further comprising:
identifying a new control based on the root cause.

10. The method of claim 8, further comprising:
correlating the existing control to another control; and
determining an impact on the other control when modifying the existing control.

11. The method of claim 1, further comprising:
providing a hierarchical view of the report based on a hierarchy of an organization.

12. The method of claim 1, further comprising:
drilling down into the risk analysis report based on a selected risk attribute.

13. The method of claim 1, further comprising:
mapping the identified risk to a component of the architectural framework.

14. An apparatus comprising:
at least one memory; and
at least one processor coupled to the at least one memory and configured to perform, based on instructions stored in the at least one memory:
obtaining risk information for an identified risk, the risk information including a first risk framework;
determining a risk score of the identified risk, the risk score encompassing a risk priority number and at least one additional risk factor;
determining at least one mitigation milestone;
adjusting the risk score to obtain a residual score based on the at least one mitigation milestone; and
reporting a risk analysis report that is indicative of the residual score for the identified risk.

15. The apparatus of claim 14, wherein the at least one processor is further configured to perform:
mapping a risk category of the identified risk from the first risk framework to a second risk framework; and
reporting the risk analysis report based on the first risk framework.

16. The apparatus of claim 15, wherein the at least one processor is further configured to perform:
revising the risk analysis report according to a different risk framework; and
displaying the revised risk assessment report.

17. The apparatus of claim 14, wherein the at least one processor is further configured to perform:
when one of the at least one mitigation factor is completed, reducing the residual score according to a weighing factor associated with said one of the at least one mitigation milestone.

18. The apparatus of claim 14, wherein the at least one processor is further configured to perform:
determining a risk disposition for the identified risk from the risk information.

19. The apparatus of claim 14, wherein the at least one processor is further configured to perform:
mapping the identified risk to a root cause based on a risk category of the identified risk.

20. The apparatus of claim 19, wherein the at least one processor is further configured to perform:
modifying an existing control based on the root cause.

21. The apparatus of claim 19, wherein the at least one processor is further configured to perform:
identifying a new control based on the root cause.

22. The apparatus of claim 20, wherein the at least one processor is further configured to perform:
correlating the existing control to another control; and
determining an impact on the other control when modifying the existing control.

23. A computer-readable storage medium storing computer-executable instructions that, when executed, cause a processor to perform a method comprising:
obtaining risk information for an identified risk, the risk information including a first risk framework;
mapping a risk category of the identified risk from the first risk framework to a second risk framework; and
reporting a risk analysis report based on one risk framework selected from the first risk framework and the second risk framework according to a target audience of the risk analysis report, the risk analysis report including the identified risk.

24. The computer-readable medium of claim 23, said method further comprising:
revising the risk analysis report according to the other risk framework; and
displaying the revised risk assessment report.

25. The computer-readable medium of claim 23, said method further comprising:
determining a risk score encompassing a risk priority number and at least one additional risk factor.

26. The computer-readable medium of claim 25, said method further comprising:
determining at least one mitigation milestone; and
adjusting the risk score to obtain a residual score based on the at least one mitigation milestone.

27. The computer-readable medium of claim 26, said method further comprising:
when one of the at least one mitigation factor is completed, reducing the residual score according to a weighing factor associated with said one of the at least one mitigation milestone.
